(19) United States
(12) Patent Application Publication
(10) Pub. No.: US 2025/0137078 A1
(43) Pub. Date: May 1, 2025

(54) COVER MATERIAL HAVING A BRAND-LIKE MARKING AND METHOD OF APPLYING A BRAND-LIKE MARKING

(71) Applicant: LEAR CORPORATION, Southfield, MI (US)

(72) Inventor: Christopher BAILEY, Warren, MI (US)

(21) Appl. No.: 18/385,754

(22) Filed: Oct. 31, 2023

(51) Int. Cl. C14C 11/00; C09D 7/41; C09D 175/04

(52) U.S. Cl. CPC C14C 11/006; C09D 7/41; C09D 175/04

(57) ABSTRACT

A segment of leather, and a color layer comprising a pigmented coating mixed with an irreversible thermochromic dye applied to the segment of leather. The irreversible thermochromic dye comprises a first portion that is activated to provide a visible marking on the segment of leather, and a second portion that is not activated in combination create a graphic image on the segment of leather. The disclosed method comprises conditioning a segment of cover material with a base coat, applying a color coating comprising an irreversible thermochromic dye and a pigmented coating to the segment of cover material, applying a top coating to the color coating, and embossing a graphic image in the color coating with a thermal embossing tool that is heated to a temperature causing a color change of the irreversible thermochromic dye by applying pressure to a first portion of the color coating.

### BRIEF DESCRIPTION OF THE DRAWINGS

FIG. 1 is a top plan view of a brand-like graphic marking on a section of cover material.

FIG. 2 is a cross-section view taken along the line 2-2 in FIG. 1.

FIG. 3 is a process flow chart showing one example of a process for manufacturing a section of cover material with the brand-like graphic marking.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

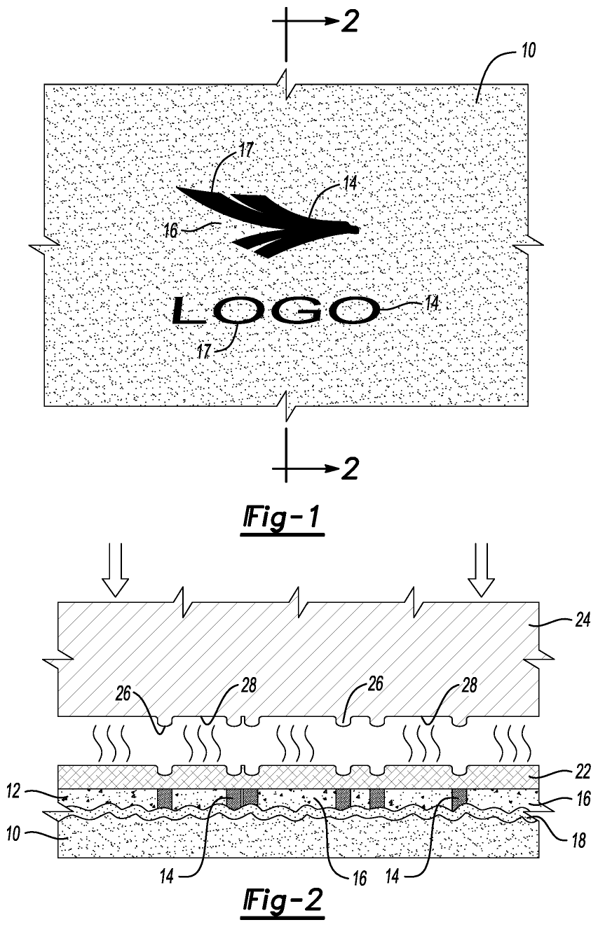

Referring to FIGS. 1 and 2, a segment of cover material 10 is illustrated that comprises a segment of leather, vinyl sheet material, polyurethane, or thermoplastic polyolefin sheet material. A color layer 12 comprises a pigmented coating mixed with an irreversible thermochromic dye (dye/pigment system) applied to the segment of leather.

The pigmented coating comprises a water-based polyurethane, a solvent-based polyurethane, or vinyl coating. The irreversible thermochromic dye comprises a leuco dye that is a type of color-changing material that changes in visible color upon reaching a transition temperature. Irreversible thermochromic dyes after changing color due to the application of pressure and a selected range of temperatures cannot be reversed by returning the material to its original temperature state. They are normally a combination of leuco dyes, color developers/activators and melt materials (often waxes) blended and then micronized to reduce particle size. The leuco dye is combined into a carrier forming an aqueous concentrate which changes from off white to a color permanently when heated above its rated temperature. As the temperature applied to the leuco dye increases, color density increases. In this application, the dye/pigment systems used are materials that transition from a clear, white, or cream tone to a black or brown color upon reaching the temperature transition point for the melt material encapsulant.

In one example, the pigmented coating includes 40% by volume of the pigmented coating mixed with 60% by volume of the leuco dye. (As referred to herein, stated percentages are by volume) It is expected the pigmented coating in the mixture can range from 5% to 40% and the leuco dye can range from 40% to 100% of that composition. One example of an irreversible thermochromic dye comprises a material currently from LCR Hallcrest designated Kromagen WB Silk Ink Black having an activation temperature range of 115° C. and 170° C.

The mixture including the irreversible thermochromic dye comprises a first portion 14 that is activated to provide a visible marking on one surface of the leather after being heated to its activation temperature and pressure is applied, A second portion 16 is not activated so that the first portion and the second portion create a graphic image 17 on the segment of cover material 10 such as leather.

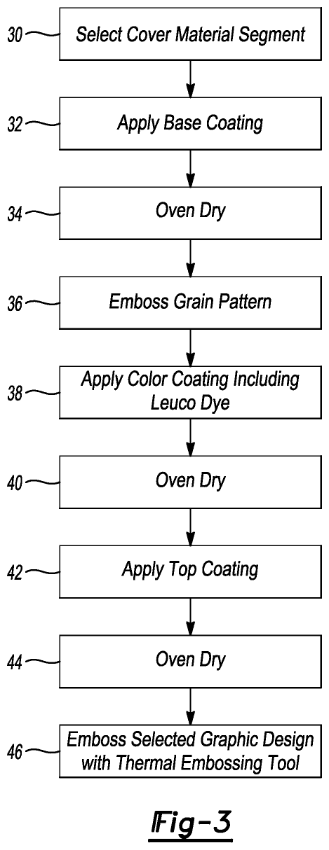

Referring to FIG. 2, The cover material 10 in one example comprises a segment of cover material 10 that can be used to cover a seat of a vehicle, or the like. If the cover material 10 is leather, a base layer 18 for filling, sealing, and adhesion is used, such as acrylic or polyurethane coating system with microspheres or foam is applied to the leather to provide a consistent appearance. The segment of cover material can then be embossed with a grain embossing tool (described with reference to FIG. 3) to provide, or enhance, the appearance of the grain on the leather. The color layer 12 is applied to the segment of cover material 10 over the base layer 18 after the grain embossing step. A top layer 22 is applied to the segment of cover material 10 over the color layer 12. The top layer 22 (more than one top layer 22 can be applied) is clear or may include less than 10% of color pigments, but can range from 0% to 8% of color pigments. Leuco dyes can be included in these coats to enhance visibility.

As will be described below with reference to FIG. 3, a thermal embossing tool 24 is heated to a temperature of between 140° C. and 200° cis pressed against the segment of cover material 10. The thermal embossing tool comprises raised areas 26 and recessed areas 28. The raised areas 26 form the first portion 14 that is activated to provide a visible marking on one surface of the leather segment 10. The recessed portion 28 forms the second portion 16 that is not activated and does not provide a visible marking on the one surface of the leather segment 10.

Referring to FIG. 3, the manufacturing process is described with reference to a process flowchart. The process begins at 30 by selecting a segment of cover material 10. The cover material 10 can comprise leather, vinyl sheet material, polyurethane, or thermoplastic polyolefin sheet material, as previously stated.

A base coating is applied to the segment of cover material 10 at 32 that forms the base layer 18. The base layer 18 comprises a filler material such as foam or microspheres in a solution of acrylics, polyesters, or polyurethanes.

The segment of cover material 10 with the base layer 18 is then heated in an over at a temperature of between 100° C. and 120° C. to dry the base layer 18 at 34. This step of the process may be omitted if the segment of cover material 10 is not leather, such as a thermoplastic polyolefin sheet, polyurethane sheet or vinyl sheet, or if the leather is unblemished.

If desired, the cover material 10 is embossed with an embossing tool at 36, to provide a grained appearance on the segment of cover material 10. This step is omitted if the appearance of the segment of cover material is to be smooth.

A color layer 12 comprises a mixture of pigmented coating and leuco dye is applied to the segment of cover material 10 at 38. The pigmented coating, for example is a water-based polyurethane, a solvent-based polyurethane, or vinyl coating. The leuco dye, as previously described, is an irreversible thermochromic dye. The proportions of the pigmented coating to the leuco dye may vary depending upon the desired appearance of the graphic image 17 to be provided on the segment of cover material 10. The color layer 12 is either applied over the base layer 18 or is applied directly to the segment of cover material 10.

After the color layer 12 is applied, the segment of cover material 10 with the color layer 12 is placed in an oven at 40 to dry the color layer 12.

A top coating is applied over the color layer 12 at 42 to form a top layer 22 that protects the segment of cover material 10 and the previously applied coatings.

The top coating is dried in an oven at a temperature of between 100° C. and 120° C. to dry the top coating and form the top layer 22.

The leuco dye is embossed at 46 with a thermal embossing tool heated to a temperature of between of between 140° C. and 180° C. to activate the leuco dye in the first portion 14 of the graphic image where the embossing tool 20 applies pressure to the segment of cover material that changes the color of the leuco dye. Less pressure is applied to the second portion of the graphic image and the leuco dye does not change color in the second portions. The color change occurs in the first portion because the leuco dye is encapsulated in a wax or other micro-encapsulation material to cause the phase change when a pH buffered solution mixes with the leuco dye component in the areas where pressure is applied while being heated thereby causing the color change in the first portions 14.

According to a first aspect of this disclosure, an article is disclosed that comprises a segment of leather 10, and a color layer 12 comprising a pigmented coating mixed with an irreversible thermochromic dye applied to the segment of leather 10. The irreversible thermochromic dye comprises a first portion 14 that is activated to provide a visible marking on one surface of the leather 10, and a second portion 16 that is not activated, wherein the first portion 14 and the second portion 16 in combination create a graphic image 17 on the segment of leather 10.

Other concepts that may be combined with the first aspect of this disclosure comprise one or more of the following:
The article can further comprise a topcoat layer 22 comprising at least one of solvent-based polyurethane, water-based polyurethane, and vinyl applied over the color layer.
The topcoat layer(s) 22 can be a translucent pigmented coating and a leuco dye.
A base coat layer 18 can be applied to the segment of leather 10. An embossed grain pattern can be formed on the segment of leather 10.
The color layer 12 can comprise a mixture of 40% by volume of a pigmented color coating and 60% by volume of a leuco dye. Alternatively, the mixture can comprise from 40% to 0% of pigmented color coating and 60% to 100% of leuco dye.

According to a second aspect of this disclosure, an article is disclosed that comprises a segment of cover material 10 coated with a color layer 12 comprising a pigmented coating and an irreversible thermochromic dye. A topcoat layer 22 is applied to the color layer 12. The irreversible thermochromic dye comprises a first portion 14 that when activated provides a visible marking 17, and a second portion 16 that is not activated.

Other concepts that may be combined with the second aspect of this disclosure comprise one or more of the following:
A base layer 18 applied to the segment of cover material 10, wherein the color layer 12 is applied over the base layer 18.
The color layer 12 further comprising a mixture of a pigmented color coating and the leuco dye.
The color layer 12 further comprising a mixture of 40% of a pigmented color coating and 60% of a leuco dye. Alternatively, the mixture can comprise from 40% to 0% of pigmented color coating and 60% to 100% of leuco dye.
The color layer 12 is applied indirectly to the segment of cover material 10 over a base coat layer 18.
The topcoat layer 22 is a clear coating of at least one of a solvent-based polyurethane, a water-based polyurethane or vinyl.
The segment of cover material 10 is selected from the group comprising leather, vinyl, or polyurethane.

According to a third aspect of this disclosure, a method is disclosed that comprises conditioning a segment of cover material with a base coat at 32, applying a color coating comprising an irreversible thermochromic dye and a pigmented coating to the segment of cover material at 38, applying a top coating at 42 to the color coating, and embossing a graphic image in the color coating at 46. A thermal embossing tool 24 is heated to a temperature causing a color change of the irreversible thermochromic dye by applying pressure to a first portion 14 of the color coating 12. In areas where reduced pressure is applied by the thermal embossing machine 24, no color change of the irreversible thermochromic dye occurs in a second portion 16 of the color coating 12.

Other concepts that may be combined with the third aspect of this disclosure comprise one or more of the following:
Applying a base coat 18 to the segment of cover material 10.
Applying a filler coating at 32 to the segment of cover material 10 and embossing a grain pattern on the segment of cover material.
The color coating 12 comprising a mixture of a pigmented color coating and the irreversible thermochromic dye (e.g., a leuco dye).
The pigmented color coating 12 comprises 40% color coating and 60% leuco dye. Alternatively, the mixture can comprise from 40% to 0% of pigmented color coating and 60% to 100% of leuco dye.
The step of embossing a graphic image 17 in the color coating with a thermal embossing machine 24 heated to a temperature higher than a curing temperature of a curing oven and less than a temperature that would be deleterious to the topcoat.
A product made according to the method of claim 14.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An article comprising:
a segment of leather; and
a color layer comprising a pigmented coating mixed with an irreversible thermochromic dye applied to the segment of leather, wherein the irreversible thermochromic dye comprises a first portion that when activated provides a visible marking on one surface of the leather, and a second portion that is not activated.

2. The article of claim 1 further comprising:
a topcoat layer comprising at least one of solvent-based polyurethane, water-based polyurethane, and vinyl applied over the color layer.

3. The article of claim 2 wherein the topcoat layer comprises a translucent, pigmented coating.

4. The article of claim 1 comprising:
a base coat layer applied to the segment of leather.

5. The article of claim 1 comprising:
an embossed grain pattern formed on the segment of leather.

6. The article of claim 1 wherein the color layer comprises a mixture of 40% of a pigmented color coating and 60% of a leuco dye.

7. An article comprising:
a segment of cover material;
a color layer comprising an irreversible thermochromic dye applied to the segment of cover material, wherein the irreversible thermochromic dye comprises a first portion that when activated provides a visible marking, and a second portion that is not activated; and
a topcoat layer applied to the color layer.

8. The article of claim 7 comprising:
a base layer applied to the segment of cover material, wherein the color layer is applied over the base layer.

9. The article of claim 7 wherein the color layer further comprises a mixture of a pigmented color coating and the leuco dye.

10. The article of claim 7 wherein the color layer further comprises a mixture of 40% of a pigmented color coating and 60% of a leuco dye.

11. The article of claim 7 wherein the color layer is applied indirectly to the segment of cover material over a base coat layer.

12. The article of claim 7 wherein the topcoat layer is a clear coating of at least one of solvent-based polyurethane, water-based polyurethane, or vinyl.

13. The article of claim 7 wherein the segment of cover material is selected from the group comprising:
leather,
vinyl,
thermoplastic polyolefin, and
polyurethane.

14. A method comprising:
conditioning a segment of cover material with a base coat;
applying a color coating comprising an irreversible thermochromic dye to the segment of cover material;
applying a topcoat to the color coating; and
embossing a graphic image in the color coating with a thermal embossing machine heated to a temperature causing a color change of the irreversible thermochromic dye in a first portion of the color coating while not causing a color change of the irreversible thermochromic dye in a second portion of the color coating.

15. The method of claim 14 comprising:
applying a base coat to the segment of cover material.

16. The method of claim 14 wherein the segment of cover material is leather and further comprising:
applying a filler coating to the segment of cover material; and
embossing a grain pattern to the segment of cover material.

17. The method of claim 14 the color coating comprising a mixture of a pigmented color coating and wherein the irreversible thermochromic dye is a leuco dye.

18. The method of claim 17 wherein the pigmented color coating comprises 40% color coating and 60% leuco dye.

19. The method of claim 14 wherein the step of embossing a graphic image in the color coating with a thermal embossing machine heated to a temperature higher than a curing temperature of a curing oven and less than a temperature deleterious to the topcoat.

20. The product made according to the method of claim 14.
